(19) United States
(12) Patent Application Publication
(10) Pub. No.: US 2012/0264082 A1
(43) Pub. Date: Oct. 18, 2012

(54) DEVICE AND METHOD INTENDED FOR HOLDING A PROSTHESIS IN DENTAL IMPLANTOLOGY

(76) Inventors: Claude Segura, Perpignan (FR); Claude Bes, Montpellier (FR)

(21) Appl. No.: 13/376,677

(22) PCT Filed: Jun. 10, 2010
(86) PCT No.: PCT/FR2010/000424

§ 371 Date: Feb. 21, 2012

(30) Foreign Application Priority Data
Jun. 10, 2009 (FR) 0902814
Nov. 25, 2009 (FR) 0905663

(51) Int. Cl. A61C 8/00

(52) U.S. Cl. 433/174

(57) ABSTRACT

The invention relates to a device intended for connecting a prosthesis to a dental implant or directly to the jawbone of a patient, of the type including a pier (1) provided with a frustoconical head (13) with a half-cone angle (A) and a linking capsule (3) provided with a frustoconical cavity (31) suitable for receiving said head. The device according to the invention is essentially characterised in that the value of the angle (A) is equal to that of the angle (B), which corresponds to the maximum angle of an implant belonging to a single jaw, such that the cone distances of the conical portions of any pair of heads (13) and capsules (3) belonging to a single prosthesis (4) are never undercut relative to the path of insertion (Z) of said prosthesis, only using a single type of capsule and not having to observe any specific location or angle for each pier or each capsule during prosthesis implantation.

### FIELD OF THE INVENTION

The present invention relates to a device used in dental implantology, for connecting a prosthesis, of the bridge or appliance type, to an implant or directly to the jaw bone of a patient.

It also relates to the method for the implementation of the prosthesis using the aforementioned device.

### TECHNOLOGICAL BACKGROUND

The most common dental implants are generally connected to metallic stumps, screw-retained in their upper part. The practitioner has, by type of implant, a range of stumps of various diamentric dimensions and angulations that he choses case by case and that he positions according to the inclination of each of them in relation to the axis of insertion of the prosthesis in order to make up for disparallelisme that still exists between the different implants connected to a common prosthesis. This, when completed, is permanently sealed or screw-retained in the mouth, directly on the stumps.

Such implants and methods have several types of disadvantages.

The first are related to the design of the implants:
the need, by type of implant, to possess a set of specific stumps ;
in the case of removal of the prosthesis for a possible operation on it, on the implant or on the jaw, because of the fact that the connection between the prosthesis and the stump is not removable, there exsits the risk of damaging it, thus remaking it;
because the stumps, are sealed in a rigid manner in the prosthesis, under the effect of masticatory pressure the stresses are transmitted directly to the implant which, over time, may require an operation with removal of the prosthesis.

The second are related to their implementation technique that comprises, chronologically:

a) for the practitioner, once the stump is dimensionally chosen and angularly positioned on the implant, making the impression, removing the stumps, screwing them on implant analogs and repositioning them in the impression while respecting their order (numbering) and their initial angular position (tracking);

b) for the technician, making the master model and then the prosthesis while still respecting their numerical positions and their different angulations;

c) finally, for the practitioner, replacing the aforementioned stumps, screw-retained on the implants, while still respecting their order and initial angular position and sealing or screwing the prosthesis to the stump;

in other words, numerical and angular tracking at each stage of making of the prosthesis

Only the problems related to the removal of the prosthesis were addressed in the patents EP1627612 and US2002177103 by means of a cap designed to be inserted in the prosthesis, a head designed to fit into the aforementioned cap, having frustoconical shape for reasons of positioning and centering, an elastic and split ring connecting element.

In particular, the patent EP1627612, paragraph 003, says, for the tapered head, a tilt as small as possible, between 8 and 15 degrees, to facilitate the assembly and the disassembly.

All the other problems listed before are neither discussed nor addressed in the aforementioned documents. It is the same for the patent EP0843989.

SUMMARY OF THE INVENTION

The invention aims to provide a device, used in dental implantology, designed to connect a prosthesis to a dental implant or directly to the jaw bone of a patient, which has an object of eliminating the drawbacks mentioned above.

The device according to the invention comprises:
a monolithic abutment, comprising a threaded rod adapted to be screwed into an implant or directly into the mandibular or maxillary jaw bone of a patient, a median transgingival base and a frustoconical head whose generatrices form, relative to the axis of the aforementioned abutment, a well defined angle A;
a cap, adapted to promote the permanent or removable connection of the head of the abutment of the prosthesis, fitted with a frustoconical cavity, adapted to receive the aforementioned head, whose generatrices form, relative to the axis of the aforementioned cap, an angle A that has a value identical to that of the angle A relative to the head of abutment;

the aforementioned prosthesis has an insertion axis forming with the axis of the abutment an angle B that also corresponds to the inclination of the implant.

The invention is essentially characterized in that the value of the angle A is equal to that of the angle B that corresponds to the maximum inclination of an implant within the same jaw, so that the generatrices of the conical parts of any pair of heads and of caps, within the same prosthesis, are never undercut relative to the insertion axis of the aforementioned prosthesis, and this is while using only one type of cap and without having to comply with any location and any angulation, for each abutment or each cap during the implantation of the prosthesis.

Such a design enables avoidance of:

a) any angular positioning of the head and any very specific location of the abutment, through the implementation process of the prosthesis,

b) problems of lack of parallelism existing between implants connected to a given prosthesis.

c) any dimensional choice of stumps: a single type of abutment and a single type of cap suffice to make a prosthesis.

In practice, the angle A can be in the range of values included between 15 and 35 degrees.

According to another advantageous feature of the invention, related to the removable aspect of the connection between the prosthesis and implants:
the head of the abutment is fitted with an annular groove adapted to receive the inner part of an elastic annular segment, noteably metallic;
the frustoconical cavity of the cap is fitted with an annular groove adapted to receive the outer part of the aforementioned annular segment so as to make a detachable “clipped” connection between the head of the implant-abutment and the cap which is designed to be integrated with the prosthesis during its casting or be bonded after it.

Such a design enables:
easily removing the prosthesis, without having to loosen it or to unscrew it, either for a clinical audit or for the needs of daily dental hygiene;
operating, either on an implant or on an element of the prosthesis without having to operate on all of the aforementioned parts, with the risk of having to remake the prosthesis in its entirety.

All this is made possible by the fact that parallelism is automatically carried out by the conical heads as defined above.

According to another advantageous feature of the invention, the cap is covered, on its exterior part, with a layer of an elastomeric material designed to create a physical-mechanical mobility replacing the physiological mobility that no longer exists on the implants because of their osseo integration.

According to the specifics of implementation of the invention:
in the case of a bridge (fixed denture), generally obtained by metallic casting, the cap is attached in a rigid manner to the aforementioned bridge;
in the case of a dental appliance (removable denture), generally obtained by resin casting, the cap has a spherical outer shape adapted to allow it a slight anteroposterior rotating movement relative to the aforementioned appliance under the effect of masticatory pressures.

The problems encountered, in dental implantology, by the practitioners and the dental technicians relate more particularly:
to the lack of parallelism exsiting between the implants for a given prosthesis;
to the care taken at each stage of making of the prosthesis in order to satisfy the angular positioning of the various implants ;
to the risks incurred at the time of removal of implants;

are fully resolved with the design of the invention as described and illustrated.

In addition, only a single type of abutment and cap is used.

Another advantage of the invention resides in the fact that known techniques and materials for manufacture and installation of the implants and prostheses are used.

The implant abutment according to the invention can be used:
either as as a abutment designed to be screwed into an implant; or
as a full implant designed to be screwed directly into the jawbone.

### DESCRIPTION OF THE FIGURES

The features and advantages of the invention will appear more clearly on reading the detailed description that follows of at least one preferred implemeation mode thereof given by way of non limiting example and illustrated in the accompanying drawings.

In the drawings:
FIGS. 1 and 2 are two longitudinal section working views, before and after assembly, of a prosthesis fitted with two caps connected to two abutments, or implants, positioned along two axes having opposite inclinations of maximum value, in opposition, in order to highlight the principle and the operating limits of the constituent elements of the invention;
FIG. 3 is a longitudinal section view of the device according to the invention, applied to the case of a bridge, fitted with a removable connection means;
FIG. 4 is a in longitudinal section view of the device according to the invention, applied to the case of a dental appliance, fitted with a removable connecting means.

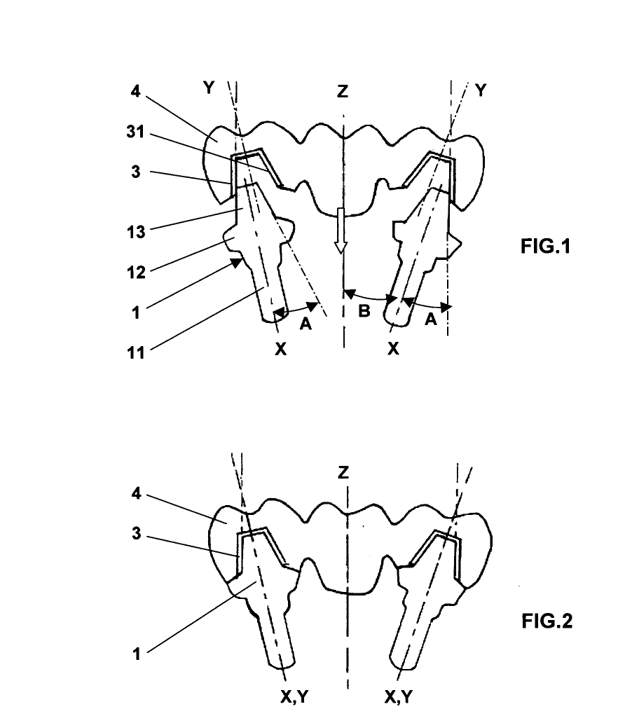

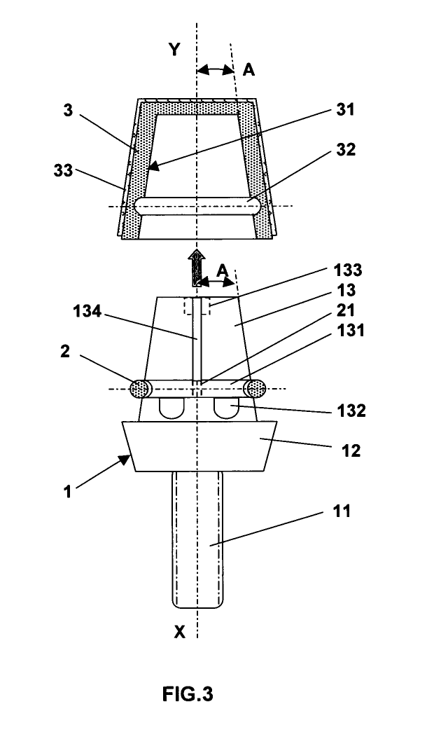

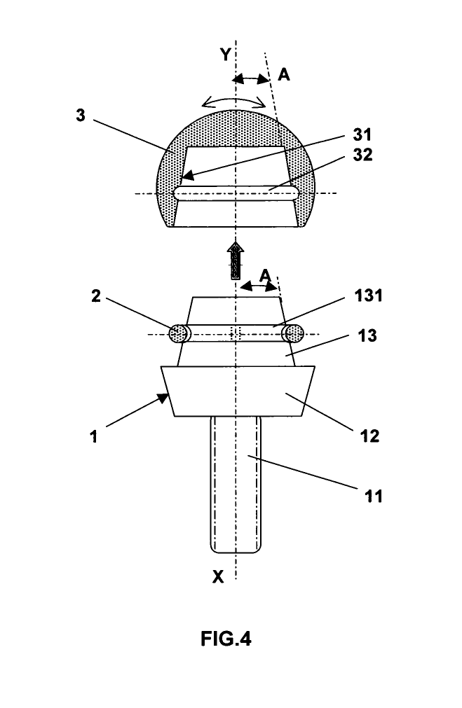

### DETAILED DESCRIPTION OF THE INVENTION

The device illustrated in the figures comprises:
a monolithic abutment (1), comprising a threaded rod (11) adapted to be screwed into an implant or directly into the mandibular or maxillary jaw bone of a patient, a median transgingival base (12) and a frustoconical head (13) whose generatrices form, relative to the axis (X) of the aforementioned implant abutment, an angle (A);
a cap (3), adapted to promote the permanent or removable connection of the head (13) of the abutment (1) and of the prosthesis (4), fitted with a frustoconical cavity (31), adapted to receive the aforementioned head (13), whose generatrices form, relative to the axis (Y) of the aforementioned cap, an angle (A) that has a value identical to that of the angle (A) relative to the head (13) of abutment (1).

The aforementioned prosthesis (4) has an insertion axis (Z) forming with the axis (X) of the abutment (1) an angle (B) that also corresponds to the inclination of the implant.

The value of the angle (A) is equal to that of the angle (B) corresponding to the maximum inclination of an implant within the same jaw, so that the generatrices of the conical parts of any pair of heads (13) and caps (3) within the same prosthesis (4), are never undercut relative to the insertion axis (Z) of the aforementioned prosthesis and this one using only one type of cap and without having to comply with any location and any angulation, for each abutment or each cap during the implantation of the prosthesis.

The angle (A) is chosen in the range of values included, without limitation, between 15 and 35 degrees. It will be defined according to standard practice in dental implantology.

FIGS. 1 and 2 show the operation of the concept according to the invention.

The abutment implants are deliberatly positioned according to extreme opposite inclinations in order to show the limits of the invention. In this case, the extreme opposite generatrices of the cone truncs (13) and (31) are parallel to the insertion axis (Z) of the prosthesis. Thus, any other lesser inclination angle, of any other implant entering in the composition of the same prosthesis, will have all its generatrices tapered with respect to the aforementioned axis (Z).

To make the removable cap-abutment connection:
the head (13) of the abutment (1) is fitted with an annular groove (131) adapted to receive the inner part of an elastic annular segment (2);
the frustoconical cavity (31) of the cap (3) is fitted with an annular groove (32) adapted to receive the outer part of the annular segment (2) so as to make a detachable “clipped” connection between the head (13) and the cap (3).

To increase the retention of the cup on the head of the implant abutment, the segments and the annular grooves can be doubled.

In the case of a bridge, the cap (3) is integrated or bonded into the metal frame of it.

In the case of an appliance, the cap (3) is integrated into the base made of its resin and has a spherical outer shape adapted to allow it a slight anteroposterior rotating movement in the aforementioned base.

According to basic feature of the invention, in the case of a bridge, the cap (3) is covered, on its exterior part, with a layer of an elastomeric material (33) designed to create a physical-mechanical mobility replacing the physiological mobility that no longer exists on the implants because of their osseo integration. It acts as a buffer in order to prevent degradation and wasting of the bone around the implant carriers, thus ensuring a greater sustainability to the implants and to the prosthesis.

According to other implementation variations of the invention:
the base of the head (13) of the abutment (1) comprises tighlening flat sections (132) for torque wrench;
the top of the head (13) of the abutment-implant (1) comprises, in counter-relief, a clamping polygon (133) for torque wrench;
the elastic ring segment (2) is split (gap (21)) so as to enable its installation and its removal from the circular groove (131) of the head (13) ;
the head (13) of the implant abutment (1) comprises, on a generatrix of the cone trunc, a groove (134) designed to enable the removal of the annular segment (2) by means of a rod-shaped tool provided with a hooked end adapted to be inserted behind the aforementioned segment in order to extract it from the groove (131).

The implant abutment (1) can be used:
either as a abutment designed to be screwed into an implant; or
as an implant designed to be screwed directly into the jawbone.

The monolithic abutment implant can be made of titanium, zirconium or any other biocompatible material.

The cap can be made of titanium, zirconium, plastic material or any other biocompatible material.

The method of implantation of the prosthesis using the aformentioned device, comprises, chronologically:

a) for the practitioner, without being concerned about any numerical and angular positioning :
setting up the abutments, either on implants or directly in the jawbone;
positionning, on the heads of the aforementioned abutments, transfer caps, made of plastic material, having dimensions identical to those that will be inserted into the prosthesis;
taking the impression of the aforementioned assembly;
positioning, in the aforementioned impression, the abutments screwed on the implant analoges mounted over previous clipped transfer caps ;

b) for the dental technician, also without being concerned with any numerical and angular positionning:
making the master model from the impression handed over by the practitioner, in which he will, in advance, have inserted transfer caps in conjunction with the implant analogs;
replacing the transfer caps with final caps;
casting the frame (bridge) or the base (apparatus) of the prosthesis on the aforementioned caps;
making the cosmetic part of the prosthesis out of ceramic (bridge) or resin (apparatus);

c) for the practitioner, still without being concerned with any numerical and angular positionning:
positionning, by clipping, the previous final caps on the abutments or implant abutments;
bonding the prosthesis to the aforementioned caps.

The transfer cap can included, on its periphery, one or two equatorial grooves, not shown, designed for its vertical positioning and maintenance during casting of the impression.

Of course, the person of skill in the art will be able to make the invention as described and illustrated by applying and adapting known means. He will also be able to provide for other variations without departing from the scope of the invention, which is determined by the terms of the claims.

1-13. (canceled)

14. A device configured to connect a prosthesis to a dental implant or directly to the jaw bone of a patient, the device comprising:
a pair of monolithic abutments, each abutment comprising a threaded rod adapted to be screwed into an implant or directly into the mandibular or maxillary jaw bone of a patient, a median transgingival base, and a frustoconical head, generatrices of the frustoconical head forming, relative to the axis of the implant abutment, an angle (A) chosen in the range 15-35 degrees, corresponding to the maximum inclination tolerated in the mouth for implants within the same jaw;
a pair of caps, each cap adapted to promote the permanent or removable connection of the prosthesis to the head of each abutment, each cap defining a frustoconical cavity adapted to receive the head, generatrices of the head forming, relative to the axis of each cap, an angle (A) that has a value equal to that of the angle (A) of each frustoconical head,
so that, without having to comply with any location and any angulation for each abutment or each cap during the implantation of the prosthesis, the generatrices of the conical parts of any pair of heads and caps within the same prosthesis are never undercut relative to the insertion axis of the prosthesis.

15. A device according to claim 14 further including a transfer cap, made of plastic material, having dimensions identical to that of the connection cap, configured to be placed on the head of each abutment during the realization step of the master model and fitted, at its periphery, with one or two equatorial grooves configured for its maintenance and vertical positioning during casting of the impression.

16. A device according to claim 14 wherein:
the head of the abutment is fitted with an annular groove adapted to receive the inner part of an elastic annular segment;
the frustoconical cavity of the cap is fitted with an annular groove adapted to receive the outer part of the annular segment so as to make a detachable connection between the head and the cap.

17. A device according to claim 14 wherein, in the case of a bridge, the cap is integrated or bonded into its metal frame.

18. A device according to claim 17 wherein the cap is covered, on its exterior part, with a layer of an elastomeric material to create a physical-mechanical mobility replacing the physiological mobility that no longer exists on the implants because of their osseo integration.

19. A device according to claim 14 wherein, in the case of an appliance, the cap is integrated into the base made of its resin and has a spherical outer shape adapted to allow it a slight anteroposterior rotating movement in the base.

20. A device according to claim 14 wherein the base of the head of the abutment comprises tightening flat sections for torque wrench.

21. A device according to claim 14 wherein the top of the head of the abutment comprises, in counter-relief, a clamping polygon for torque wrench.

22. A device according to claim 15 wherein the elastic ring segment is split so as to enable its installation and its removal from the circular groove of the head.

23. A device according to claim 15 wherein the head of the abutment comprises, on a generatrix of the cone trunc, a groove configured to enable the removal of the elastic annular segment by means of a rod-shaped tool filtted with a hooked end adapted to be inserted behind the segment in order to extract it from the groove.

24. A device according to claim 14 wherein the abutment is configured to be screwed into an implant.

25. A device according to claim 14 wherein the abutment is used as an implant configured to be screwed directly into the jawbone.

26. A method of implantation of the device according to claim 14 wherein the method comprises for the dental technician, without having to comply with any location and any angulation, for each abutment or each cap:
making the master model from the impression handed over by the practitioner, in which the practitioner will have, in advance, inserted transfer caps in conjunction with the implant analogs;
replacing the transfer caps with final caps;
casting the frame or the base of the prosthesis on the caps; and
making the cosmetic part of the prosthesis out of ceramic or resin.
